(19) United States
(12) Patent Application Publication
(10) Pub. No.: US 2026/0114358 A1
(43) Pub. Date: Apr. 30, 2026

(54) Agricultural Spreader

(71) Applicant: Amazonen-Werke H. Dreyer SE & Co. KG, Hasbergen (DE)

(72) Inventor: Herbert BÄUMKER, Hilter (DE)

(73) Assignee: Amazonen-Werke H. Dreyer SE & Co. KG, Hasbergen (DE)

(21) Appl. No.: 18/872,167

(22) PCT Filed: May 22, 2023
(86) PCT No.: PCT/EP2023/063562

§ 371 Date: Dec. 5, 2024

(30) Foreign Application Priority Data
Jun. 8, 2022 (DE) 10 2022 114 326.0

(51) Int. Cl. A01C 17/00; E01H 10/00

(52) U.S. Cl. CPC A01C 17/001; E01H 10/007

(57) ABSTRACT

An agricultural spreading device, with a storage container for holding a spreading material, a spreading unit for distributing the spreading material over an utilizable area, a feed chute with a chute inlet for introducing the spreading material from the storage container and a chute outlet for feeding the spreading material onto the spreading unit, wherein an additional chute is provided that is insertable into the feed chute for adjusting the chute outlet.

### CROSS REFERENCE TO RELATED APPLICATIONS

The present application claims priority under 35 U.S.C. § 365 to PCT/EP2023/063562 filed on May 22, 2023 and under 35 U.S.C. § 119(a) to German Application No. 10 2022 114 326.0 filed on Jun. 8, 2022, both of which are incorporate by reference in their entireties.

### TECHNICAL FIELD

The disclosure relates to a spreading device, in particular an agricultural spreading device, with a storage container for storing a spreading material, a spreading unit for distributing the spreading material over an utilizable area, a feed chute with a chute inlet for introducing the spreading material which can be fed from the storage container and a chute outlet for feeding the spreading material onto the spreading unit.

### BACKGROUND

Such spreading devices, for example fertilizer spreaders, generally comprise a storage container for holding the spreading material to be distributed, often in granular or powder form, which is often configured in the form of a large-volume container, often open at the top, for storing the spreading material.

In this context, the term “spreading material” refers to all grain, granular or powdery materials that can be used in agriculture and distributed with such spreading devices, in particular mineral fertilizers, lime, seeds, etc. The term “distribution” refers to all types of spreading of the spreading material with such spreading devices on utilizable areas, such as fields, meadows, etc.

To distribute the spreading material, the spreading devices are usually driven or pulled along parallel strips spaced apart from each other over the utilizable area, for which purpose the spreading devices can either be attached to tractors, such as tractors, mounted on them or configured to be self-propelled. The spreading unit is used to distribute the spreading material from the storage container over a wide area, often in a fan shape behind the spreading device, whereby the spreading width of the spread seed often considerably exceeds the width of the spreading device. The spreading unit generally comprises several spreading devices for distribution, which are often configured as rotatably mounted spreading discs and over which the spreading material is distributed using centrifugal forces. In order to adjust the spreading width and the spreading pattern, i.e. the distribution of the spreading material on the utilizable area, the rotational speed of the spreading discs can, for example, be adjustable in such spreading devices.

The spreading material that can be fed from the storage container is usually fed into such spreading devices via a feed chute. Such feed chutes often comprise a chute inlet for introducing the spreading material that can be fed from the storage container. The spreading material is often fed into the chute inlet of the feed chute by gravity or via a conveyor extending between the storage container and the feed chute, such as conveyor belts or screw conveyors. The chute outlet is usually configured for gravity-based feeding of the spreading material onto the spreading unit and is arranged above the spreading devices or spreading discs. The spreading material is fed essentially vertically from the chute outlet onto the spreading discs. The area in which the spreading material is fed onto the spreading discs has an influence on the spreading pattern and is known as the feeding point.

To ensure a uniform spreading pattern with different spreading materials, it is also known to adjust the feeding point, for example depending on the degree of moisture or the flowability of the respective spreading material.

Against this background, DE 1 281 733 B discloses a spreading device in which the feed chute is arranged adjustably in order to change the feeding point. The feed chute can be mounted offset in several positions transversely to the direction of travel of the spreading device and can also be pivoted in a certain angular range in order to change the feeding point of the spreading material onto the spreading discs. In this context, WO 01/50836 A1 discloses a feed chute with internal guide plates, which can be manually fastened in various swivel positions using fastening means. With these feed chutes, it is basically possible to adjust the feeding point to adapt to the properties of the spreading material, but manual adjustment is time-consuming and user-unfriendly.

To avoid the aforementioned disadvantages, DE 41 34 315 A1 proposes a spreading device in which the feeding point can be adjusted via a metering element consisting of several motor-adjustable slides. This allows the feeding point to be adjusted in a user-friendly manner even while driving. However, it has proven to be a disadvantage with this spreading device that several servomotors are required, which not only entail a comparatively complex structure, but also require a lot of maintenance and involve a certain risk of failure.

### SUMMARY

Against this background, the disclosure sets out to provide a spreading device in which the feeding point can be adjusted in a simple and user-friendly manner.

This task can be solved in a spreading device of the types mentioned herein. Advantageous further embodiments are also described herein.

The additional chute that can be used for adjusting the chute outlet in the feed chute allows the feeding point to be adjusted in a user-friendly manner with virtually just one hand movement. The feeding point can be adjusted in a structurally simple manner via the position of the chute outlet of the feed chute. This results in both operator-and maintenance-friendly adaptation of the spreading pattern to different spreading material properties.

An advantageous further development in this context is that the feed chute is configured in the shape of a funnel with a cross-section that tapers from the chute inlet to the chute outlet. Such a configuration enables simple gravity-based feeding of the spreading material onto the spreading unit. The larger cross-section at the chute inlet enables simple and low-loss introduction of the spreading material into the feed chute. The tapered cross-section at the chute outlet enables reliable and defined feeding of the spreading material onto the spreading unit. In particular, the feed chute can comprise a rectangular cross-section and be configured to be closed on two essentially vertically extending sides and open on the other two essentially vertically extending sides.

In this context, it has proven to be advantageous if the feed chute comprises at least two funnel-shaped chute segments running towards each other. Such an arrangement enables a directed, gravity-based feeding of the spreading material onto the spreading unit. In this context, it has proven to be structurally advantageous if one chute segment is arranged on the inside, i.e. in a central area of the spreading device, and the other chute segment is arranged on the outside, i.e. in an outer area of the spreading device. It has proven to be advantageous if one of the slide segments, in particular the inner slide segment, is configured as the main slide element for feeding the main portions of the spreading material onto the spreading unit and the other slide segment is configured as a secondary slide segment. The secondary chute segment can advantageously serve to stiffen the feed chute. In particular, the chute segments can be configured in a ramp-like manner.

From a structural perspective, it is advantageous if the cross-section tapers transversely to the direction of travel of the spreading device. This enables particularly simple and reliable guidance of the spreading material transversely to the direction of travel of the spreading device. The main direction of travel of the spreading device is forwards.

It is further proposed that the feed chute is configured to be closed at its front and/or at least partially open at its rear. Such an arrangement allows unwanted particles contained in the spreading material to be moved out of the spreading device via the at least partially open rear side. The closed front of the feed chute prevents spreading material from falling out of this area and any negative influence on the spreading pattern that may result from this. In addition, the closed front of the spreading device can effectively protect the tractor and other components that may be arranged in the area of the front from contact with the spreading material. The front side of the feed chute is located at the front in the main direction of travel and the rear side is located at the rear in the main direction of travel.

It is further proposed that the feed chute is configured as a double chute with two chute outlets. Such an arrangement advantageously enables the spreading material to be fed onto the spreading unit at two feeding points simultaneously.

In this context, it has proven to be advantageous from a structural point of view if the double chute comprises a common chute inlet. This allows the spreading material to be fed from the storage container into the feed chute reliably and with little loss.

It is also preferable if the feed chute configured as a double chute comprises a separating point arranged between the chute inlet and the two chute outlets for dividing the spreading material introduced via the chute inlet into two subsets. Such an arrangement enables the spreading material to be fed evenly onto the spreading unit at two feeding points. In particular, the separating point can extend along the direction of travel of the spreading device. In this context, it is advantageous if the separating point is configured in such a way that a defined position and/or installation position is formed for the additional chute. This enables particularly simple and reliable guidance of the additional chute. In addition, such an arrangement can enable self-positioning of the additional chute inserted into the feed chute. Furthermore, such an arrangement allows incorrect positioning of the additional chute to be avoided. In this context, other means for guiding and/or positioning the additional chute relative to the feed chute are also conceivable, for example positioning aids or stops.

From a structural perspective, it has proven advantageous when the feed chute is configured to be mirror-symmetrical about the separating point. This allows the spreading material introduced via the chute inlet to be divided evenly into two subsets. Furthermore, such an arrangement can also prove advantageous with regard to simplified production of the feed chute.

In an advantageous further development of the disclosure, it is proposed that the additional chute is configured in such a way that the chute outlet is adjusted in two directions by inserting the additional chute. Such an arrangement enables simple, user-friendly adjustment of the feeding point on the spreading unit in two directions. In particular, such an arrangement can be used to limit and/or reduce the size of the chute outlet, thus enabling a particularly targeted and defined feeding of the spreading material onto the spreading unit at the feeding point.

In this context, it has proven to be advantageous if one of the directions extends longitudinally and the other direction transversely to the direction of travel of the spreading device. Such an arrangement allows user-friendly and repeatable adjustment of the feeding point.

In a further development of the disclosure, it is proposed that the additional chute is configured in the form of a ramp with an angled cross-section. A reliable and structurally simple adjustment of the chute outlet in both directions can be achieved via the two legs of the ramp, which are arranged at an angle to each other. In this context, it has proven to be advantageous if the additional chute is configured in the form of a box-shaped funnel, open on two sides, with a tapered, in particular rectangular, cross-section between the additional chute inlet and the additional chute outlet.

With regard to the additional chute, it is also proposed that it be at least partially closed at the rear and/or configured to be open at the front. Such a configuration allows the seed to be guided well in the area of the rear. Furthermore, the feed chute and the additional chute inserted into the feed chute can thereby together form a closed funnel with a tapering cross-section around its circumference. Such an arrangement allows for particularly low-loss guidance of the spreading material, since little spreading material can fall out of the feed chute. The front side of the additional chute is located in the main direction of travel at the front when inserted and the rear side is located in the main direction of travel at the rear.

It is further proposed that the additional chute comprises a longitudinal adjustment ramp inclined longitudinally to the direction of travel for adjusting the chute outlet in one direction and a lateral adjustment ramp inclined transversely to the direction of travel for adjusting the chute outlet in the other direction. Such an additional chute allows the chute outlet to be adjusted in both directions.

In this context, it has proven to be advantageous from a structural point of view if the longitudinal adjustment ramp is arranged at the rear of the additional chute. This allows effective guidance of the spreading material from the chute inlet to the chute outlet along the direction of travel. In particular, the longitudinal adjustment ramp can extend from the chute inlet to the chute outlet at an angle to the direction of travel. However, it is also conceivable to arrange the longitudinal adjustment ramp at the front of the additional chute if this proves to be useful.

It is further proposed that the longitudinal adjustment ramp and/or the lateral adjustment ramp comprise areas with different slopes. This ensures that the longitudinal adjustment ramp and/or the lateral adjustment ramp run at an angle between the chute inlet and the chute outlet. Such an arrangement has proven to be particularly advantageous with regard to trouble-free and low-congestion guidance of the spreading material between the chute inlet and the chute outlet.

From a structural perspective, it is advantageous in this context if the lateral adjustment ramp has a greater slope in the area of the chute inlet than in the area of the chute outlet. This makes it possible to configure the additional chute to be steeper in the area of the chute inlet than in the area of the chute outlet. Such a configuration can prevent the spreading material from backing up in the feed chute and ensures that the spreading material is continuously fed onto the spreading unit.

In a further development of the disclosure, it is proposed that the transverse adjustment ramp of the additional chute at least partially covers one of the chute segments of the feed chute in the inserted position. This allows a particularly user-friendly positioning of the additional chute relative to the feed chute by simply inserting the additional chute. In this context, it is particularly advantageous if the lateral adjustment ramp of the additional chute in the inserted position at least partially, preferably completely, covers the inner chute segment of the feed chute.

With regard to the structural configuration of the additional chute, it has proven advantageous if the longitudinal adjustment ramp has, in the vertical direction, an inclined inlet area for guiding the spreading material in the area of the chute inlet, an inclined outlet area for guiding the spreading material in the area of the chute exit and a transition area that is arranged between the inlet area and the outlet area, is angled with respect to these areas and extends in particular vertically.

In this context, it is further proposed that the additional chute is configured as a double additional chute with two longitudinal adjustment ramps, two lateral adjustment ramps and a separating point arranged between the lateral adjustment ramps. Such an arrangement enables the simultaneous adjustment of two chute outlets of the feed chute in a user-friendly manner and thus the simultaneous adjustment of two feeding points on the spreading unit.

In this context, it is structurally advantageous if the lateral adjustment ramps extend transversely to the direction of travel of the spreading device, spreading out from the separating point, and the longitudinal adjustment ramps are arranged parallel to the direction of travel of the spreading device at the rear of the double additional chute. This arrangement of the longitudinal adjustment ramps also helps to reduce the loss of spreading material during spreading operations of the spreading device, as less spreading material can fall out through the open back of the feed chute.

With regard to user-friendly assembly of the additional chute, it has proven to be advantageous if the additional chute configured as a double additional chute comprises a saddle-like insertion shape for insertion into the feed chute. Such an arrangement allows the roof-like configured additional chute to be mounted onto the feed chute in a user-friendly manner. Positioning or assembly errors can thus be avoided. Furthermore, such an arrangement enables the additional chute to be mounted on the feed chute in a captive manner, even during the distribution of the spreading material and any vibrations that occur. Furthermore, such an arrangement allows the additional chute to position itself relative to the feed chute during the distribution of the spreading material.

In this context, it is preferable if the additional chute is configured with mirror symmetry to the separating point. Such an arrangement enables further simplified, more user-friendly positioning of the additional chute relative to the feed chute.

It is proposed that the additional chute be configured such that it can be mounted with a lower side of the separating point on an upper side of the separating point of the feed chute configured as a double chute. Such a configuration enables a particularly time-saving, user-friendly assembly of the additional chute in the feed chute, which can be carried out quickly and without errors even by inexperienced assembly and/or operating personnel.

In a further embodiment of the disclosure, it is further proposed that the additional chute can be detachably fastened to the feed chute in the inserted position, in particular by screwing, tool-free and/or by means of quick-release clamping devices. Such fastening enables time-saving and user-friendly assembly and disassembly of the additional chute in the feed chute. Furthermore, such an attachment allows secure positioning of the additional chute relative to the feed chute, in particular in the event of shocks or vibrations occurring during distribution.

In this context, a structurally preferred embodiment provides that the additional chute comprises a tab-like fastening area for attachment to the feed chute.

With regard to the arrangement of the fastening area, it has proven to be structurally advantageous when it extends vertically from the upper side of the longitudinal adjustment ramps.

It is also advantageous if the fastening area extends transversely to the separating point and comprises a fastening hole arranged centrally on the fastening area. The good accessibility of the fastening area enables particularly time-saving and user-friendly installation of the additional chute in the feed chute. In this context, a configuration of the fastening hole as a square hole is particularly advantageous.

In this context, it is preferred if the additional chute comprises two tab-like fastening areas that extend downward from the lateral adjustment ramps. In this context, it is particularly advantageous from a structural point of view if the fastening areas extend vertically downward from the lateral adjustment ramps.

With regard to the structural configuration of the fastening areas, it has been found to be advantageous if these extend parallel to the separating distance and each comprise a fastening hole arranged in the area of the rear side of the feed chute.

In an advantageous further development, it is proposed that the additional chute comprises two box-shaped mounting elements, which are arranged on the underside of the lateral adjustment ramps and extend parallel to the fastening areas. Such mounting elements enable advantageous, user-friendly and time-saving assembly of the additional chute on the feed chute. In this context, the mounting elements can also serve as spacers to bridge assembly distances.

It is further proposed that the additional chute is composed of sheet metal parts, in particular bent sheet metal parts. Such a structure has proven itself in terms of a lightweight construction. Furthermore, such a configuration made of sheet metal parts can be advantageous from a manufacturing point of view.

In a further advantageous development of the disclosure, it is proposed that the spreading device comprises several interchangeable additional chutes for the stepwise adjustment of the chute exit. Such a configuration enables a particularly simple, stepwise adjustment of the chute exit and thus a particularly user-friendly adaptation of the feeding point to the properties of the spreading material to be distributed. This makes it possible to precisely adjust the spreading material to its properties, in particular to different degrees of moisture. By exchanging the additional chutes, the chute exit can be easily adjusted in several stages, allowing different feeding points to be set on the spreading unit.

In this context, it is proposed that the additional chutes differ in terms of their longitudinal and/or lateral adjustment ramps. In this way, an advantageously large range of feeding points, which differ in their position in the longitudinal and transverse directions, can be covered with different additional chutes.

It is further proposed that the spreading unit is arranged below the chute outlet. Such an arrangement of the spreading unit enables simple and reliable adjustment of the feeding point via the adjustment of the chute outlet. In addition, the spreading material can be fed onto the spreading unit in an uncomplicated, in particular gravity-based manner.

With regard to the spreading unit, it is proposed that it comprises at least two spreading devices, with each spreading device being assigned a chute exit. Such an arrangement enables a user-friendly, simultaneous adjustment of the feeding point for each of the spreading devices.

In this context, it is further proposed that the spreading devices are configured as spreading discs, each rotatable about a vertical rotation axis, for the purpose of distributing the spreading material based on centrifugal force. Such a configuration of the spreading devices enables a reliable spreading material distribution in a spreading fan-like manner behind the spreading device in the direction of travel. The spreading width can be advantageously adjusted by the rotational speed of the spreading discs. In particular, a high rotational speed of the spreading discs can be set to produce a large spreading width. Furthermore, the spreading fans that can be generated by the respective spreading devices can overlap at least partially to ensure adequate distribution of the spreading material and a desired spreading rate of the spreading material.

With regard to the spreading devices, it has been found to be advantageous if these comprise opposite directions of rotation. Such a configuration enables a particularly advantageous and uniform distribution of the spreading material in an even spreading pattern in the direction of travel behind the spreading device. In particular, it is proposed that one of the spreading discs rotates clockwise and the other spreading disc counterclockwise. In this context, it is particularly advantageous in terms of achieving the widest and most even spreading pattern possible if the left-hand spreading disc in the direction of travel rotates clockwise and the right-hand spreading disc in the direction of travel rotates anticlockwise.

With regard to an even distribution of the spreading material, it is preferable if the spreading devices comprise spreading vanes for guiding the spreading material. Such spreading vanes enable particularly reliable guidance of the spreading material on the spreading discs and effective distribution of the spreading material. In particular, the spreading vanes can be configured to be adjustable in order to change the spreading width.

In an advantageous further development, it is proposed that the chute outlet is configured to feed the spreading material into one feeding point on each of the spreading devices. The feeding point is an area which is configured to be adjustable in two directions by the additional chute. By adjusting the feeding point, it is possible to adapt to the properties or characteristics of the spreading material.

In this context, it has proven advantageous that the feeding point is adjusted in such a way that the feeding point in the direction of rotation of the spreading device is in front of the feeding point without the additional chute. This can achieve a more even distribution of the spreading material on the utilizable area, especially with spreading material with an increased moisture content. In a similar way, the feeding point can be adjusted when the additional chute is used, so that the feeding point in the direction of rotation of the spreading device is located behind the feeding point without the additional chute being used. Thus, for example, depending on the properties of the spreading material, an adaptation of the spreading pattern can be made possible by means of the additional chutes that can be inserted into the feed chutes.

In an advantageous further development of the disclosure, it is proposed that the spreading device comprises a conveyor unit for conveying the spreading material from the storage container to the feed chute. Such a conveyor unit has proven particularly useful when larger distances have to be bridged between the storage container and the feed chute. In particular, such a conveyor unit can be used to continuously feed the spreading material from the storage container into the feed chute. In this context, it is structurally advantageous to configure the conveyor unit as a conveyor belt, a screw conveyor, etc. The conveyor unit can be configured to be gravity or motor-driven.

### BRIEF DESCRIPTION OF THE DRAWINGS

Further details and advantages of the disclosure are explained below with the aid of the accompanying drawings of embodiments. However, the disclosure is not limited to these embodiments. Further embodiments may result from combining the features of individual or several of the features described above with each other and/or with individual or several features of the embodiments or claims.

FIG. 1 shows a perspective view of a spreading device according to the disclosure attached to an agricultural tractor;

FIG. 2 shows a further, perspective, sectional view of a spreading device according to the disclosure;

FIG. 3 shows a view as shown in FIG. 2 with an additional chute inserted into the feed chute;

FIGS. 4a-c shows partial perspective views of a feed chute of a spreading device according to the disclosure;

FIGS. 5a-b show partial perspective views of an additional chute of a spreading device according to the disclosure;

FIGS. 6 and 7 show exploded views as shown in FIG. 3;

FIG. 8 show a plan view as shown in FIG. 3, and

FIG. 9 show perspective side view according to FIG. 3.

### DETAILED DESCRIPTION

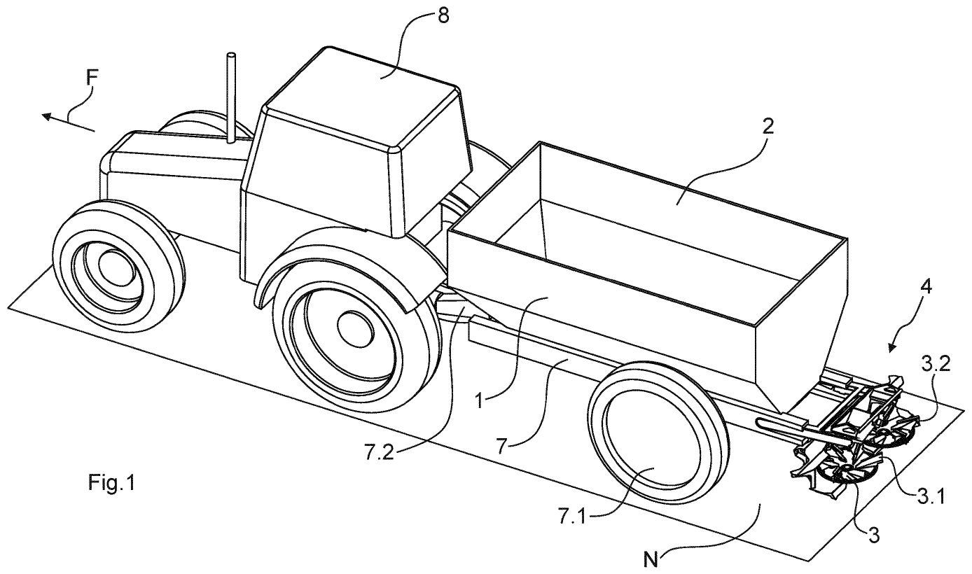

The illustrations in FIGS. 1 to 9 show a spreading device 1, in particular an agricultural spreading device 1 for distributing spreading material S on an utilizable area N, in various views, some of which are sectional or perspective views.

The spreading device 1 shown in the figures is a fertilizer spreader, but it can also be another spreading device 1 for distributing or spreading grainy, granular or powdery spreading material S, in particular mineral fertilizer, lime, seed or road salt, on an utilizable area N. Various types of utilizable area N, such as fields, meadows or pastures, or even traffic areas, can be used as the utilizable area N.

The spreading device 1 comprises a storage container 2 for receiving the spreading material S to be distributed, which is configured in the manner of a tub-shaped container that is open at the top for easy filling, see FIG. 1. The storage container 2 is used to store the spreading material S and is arranged on a chassis 7. Two impellers 7.1 are arranged laterally on the chassis 7.

As shown in FIG. 1, the spreading device 1 is attached to an agricultural tractor 8 by means of a coupling device 7.2 and is pulled over the utilizable area N in the direction of travel F to distribute the spreading material S along parallel strips spaced apart at a distance from one another. Alternatively, the spreading device 1 can also be attached to the tractor 8 or configured to be self-propelled. For the purpose of distributing the spreading material S in a flat, fan-shaped manner behind the spreading device 1, the latter comprises a spreading unit 3. The spreading unit 3 comprises two spreading devices 3.1, 3.2 in the form of rotatably mounted spreading discs, by means of which the spreading material S is distributed in a fan-shaped manner behind the spreading device 1 on the utilizable area N, using centrifugal forces.

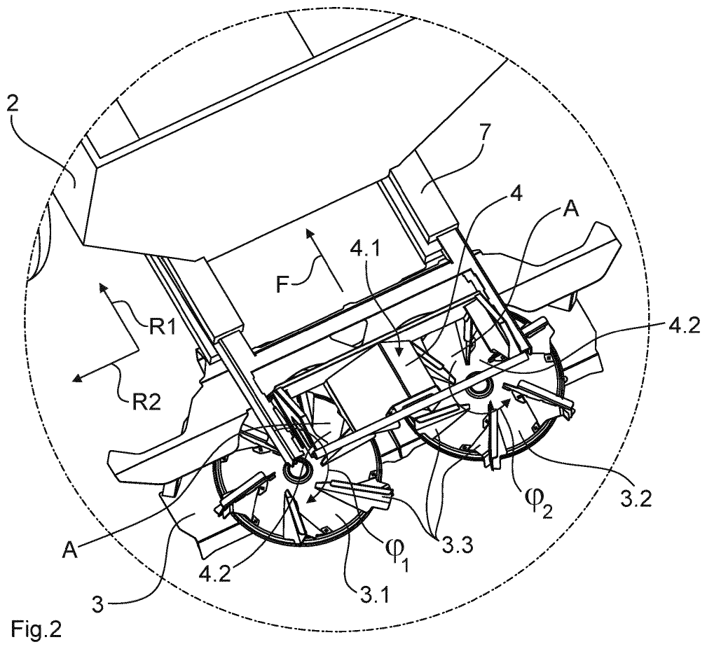

The spreading material S is fed onto the spreading unit 3 via a feed chute 4, into the chute inlet 4.1 of which the spreading material S is fed from the storage container 2 by gravity or by means of a conveyor unit not shown in the figures. The feed chute 4 has a chute outlet 4.2 arranged above the spreading devices 3.1, 3.2 of the spreading unit 3 for feeding the spreading material S onto the spreading unit 3, see FIG. 2. The feeding point A, at which the spreading material S is fed from the chute outlet 4.2 onto the spreading devices 3.1, 3.2, influences the spreading pattern, i.e. the spreading material distribution of the spreading material S on the utilizable area N.

To ensure a uniform spreading pattern with different spreading materials, in particular with spreading materials with different degrees of moisture or flow properties, such as lime with different moisture levels, the feeding point A of the spreading device according to the disclosure can be adjusted in a structurally simple and user-friendly manner. For this purpose, an additional chute 5 can be inserted into the feed chute 4, via which the chute exit 4.2 and thus also the feeding point A can be adjusted. Before the configuration and mode of operation of the additional chute 4 is explained in detail, the function of the spreading unit 3 for distributing the spreading material S is explained first, based on the illustration in FIG. 2.

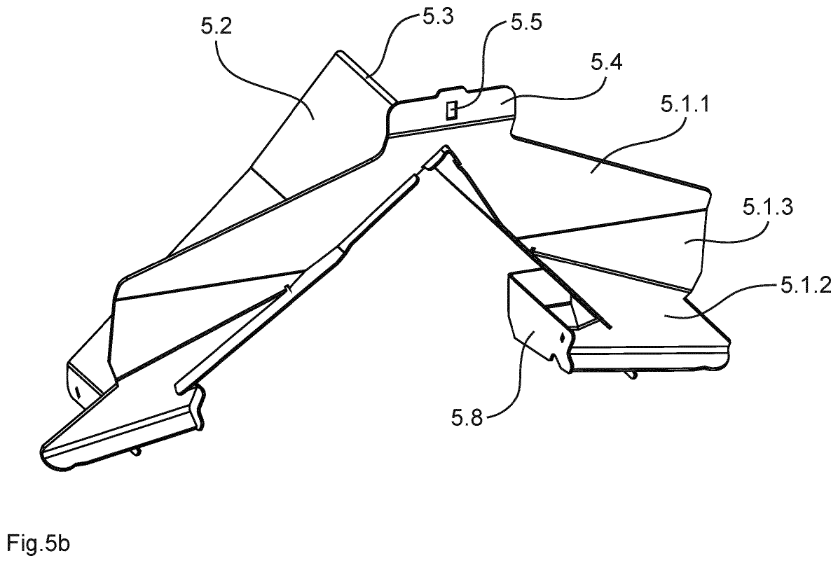

The spreading unit 3 is arranged at the rear of the spreading device 1 and comprises two identical spreading discs configured like plates as spreading elements 3.1, 3.2. The spreading devices 3.1, 3.2 are each mounted for rotation about a rotation axis D extending in a vertical direction for centrifugal force-based distribution of the spreading material S, see FIG. 6, and are arranged transversely to the direction of travel F next to each other below the storage container 2. To entrain and guide the spreading material S, the spreading devices 3.1, 3.2, configured as spreading disks, comprise several spreading vanes 3.3 extending essentially perpendicularly from their surfaces in a radial direction. The spreading devices 3.1, 3.2 comprise opposite directions of rotation φ₁, φ₂, with the left spreading device 3.1 rotating clockwise and the right spreading device 3.2 rotating counterclockwise as shown in FIG. 2.

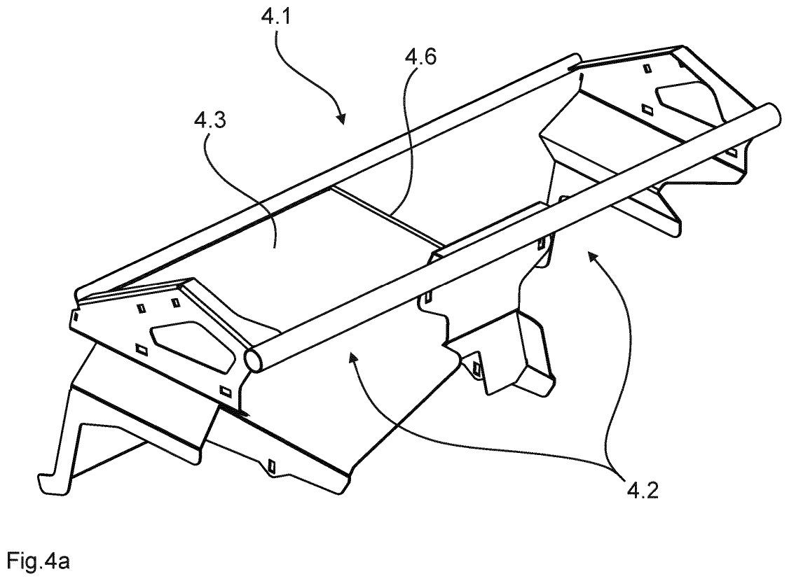

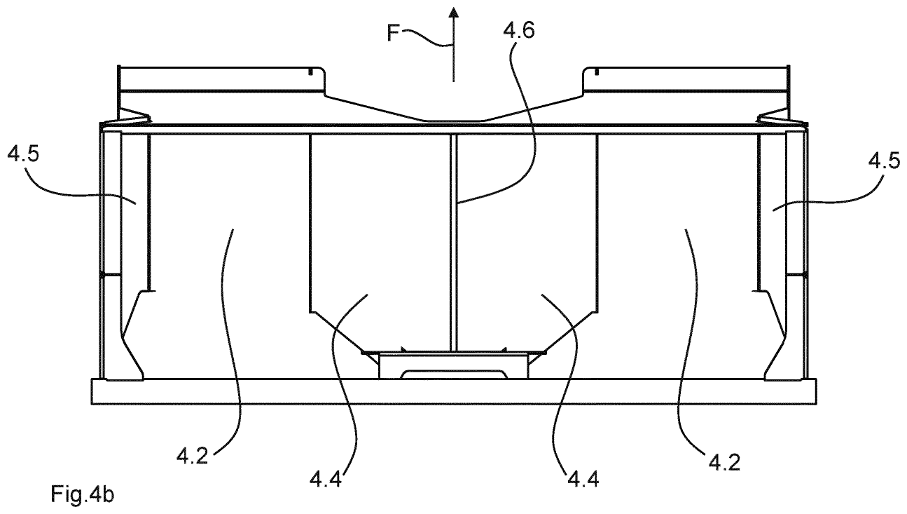

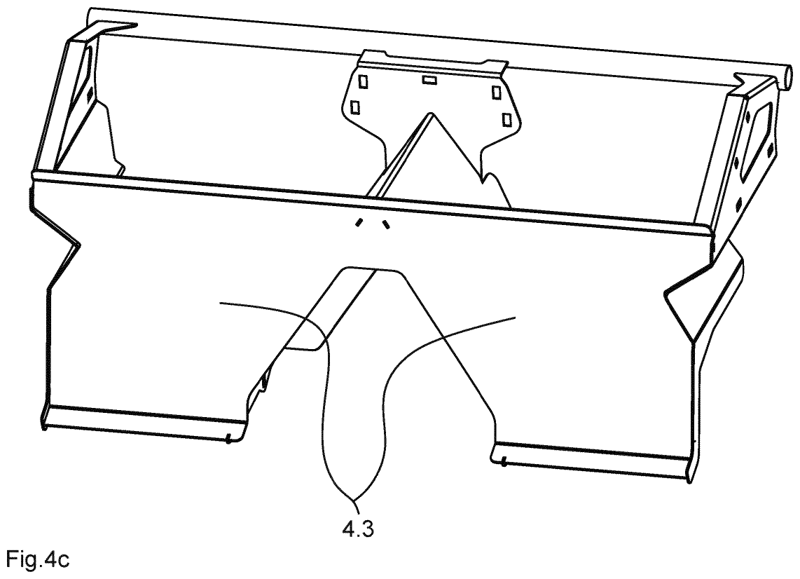

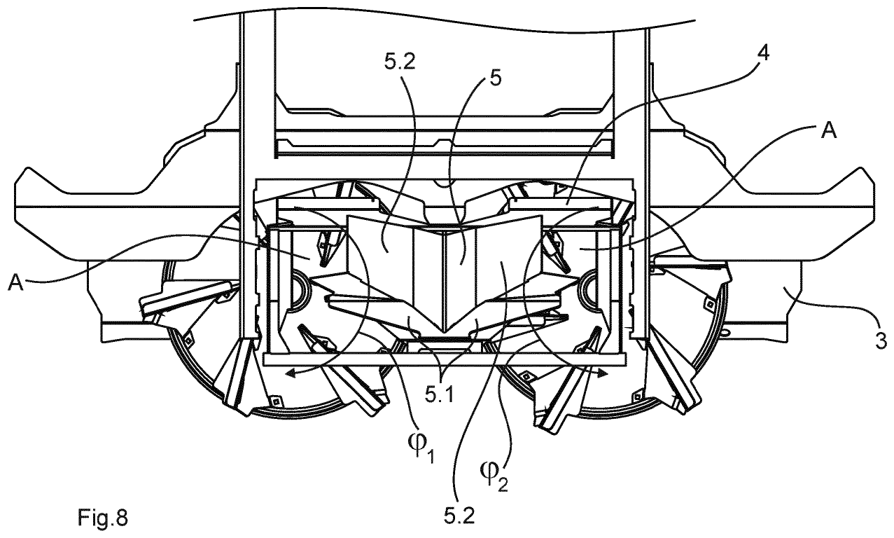

The spreading material S is fed onto the spreading devices 3.1, 3.2 at a feeding point A, see FIG. 2. The feeding point A is determined by the chute outlet 4.2 of the feed chute 4, which is arranged in a vertical direction above the spreading devices 3.1, 3.2, see also FIG. 8. The structure and function of the feed chute are explained below with reference to the illustrations in FIG. 2 and FIG. 4a-c.

The feed chute 4 is arranged between the storage container 2 and the spreading unit 3 and is attached to the chassis 7, see FIG. 2. In the present embodiment, the feed chute 4 is configured as a double chute, which is symmetrically configured on both sides of a separating point 4.6 extending in a line in the direction of travel F, see FIG. 4b. The feed chute 4 configured as a double chute comprises a common chute inlet 4.1 and two chute exits 4.2, one located above each spreading device 3.1, 3.2. Between the chute inlet 4.1 and the chute exits 4.2, the feed chute 4 is of the same design on both sides of the separating point 4.6, namely in each case funnel-shaped with a cross-section that is deflected or displaced between the chute inlet 4.1 and the respective chute exit 4.2 to guide the spreading material S, see also FIG. 4b.

The chute inlet 4.1 comprises a rectangular cross-sectional area, which is larger than the cross-sectional area of the chute exit 4.2, for the simplified introduction of the spreading material S originating from the storage container 2. For the directed, gravity-based guidance of the spreading material S from the chute inlet 4.1 to the chute exit 4.2, the two similar areas of the feed chute 4 each comprise two chute segments 4.4, 4.5 that taper towards each other in a funnel-shaped or V-shaped manner, see FIG. 4b, whereby a cross-sectional tapering is achieved transversely to the direction of travel F. The inner chute segments 4.4 are configured as main chute segments, over which a large proportion of the spreading material S is guided between the chute inlet 4.1 and the chute exit 4.2. The slide segments 4.4 spread out from the separating point 4.6, which is arranged in the center between the slide areas and extends in the direction of travel F, and are inclined transversely to the direction of travel F, see FIG. 4b. The separating point 4.6 serves to divide the spreading material S, which is supplied via the common chute inlet 4.1, evenly into two subsets T₁, T₂. In addition to guiding the spreading material S, the externally arranged chute segments 4.5 also serve to reinforce the feed chute 4 in order to increase its stability.

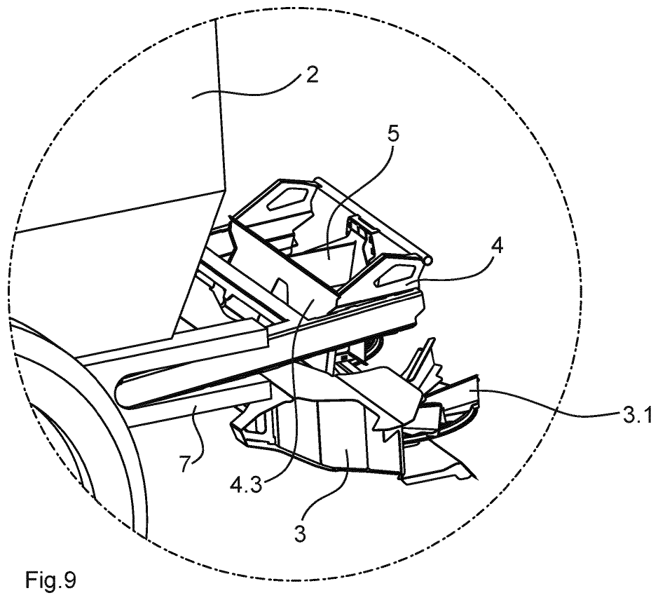

As can be seen in particular from the illustrations in FIGS. 4c and 9, the feed chute 4 is closed at its front side by means of a front wall 4.3 in order to prevent the spreading material S from falling out of this area, which would have an adverse effect on the spreading pattern, or to prevent elements of the spreading device 1 or the tractor 8 from becoming soiled. The rear side of the feed chute 4, on the other hand, is largely configured to be open, see FIG. 4a. This allows unwanted particles contained in the spreading material S, such as foreign bodies, to be moved out of the spreading device 1 before the spreading material S comes into contact with the spreading devices 3.1, 3.2.

The spreading material S can be fed onto the spreading devices 3.1, 3.2 via the feed chute 4, as shown in FIG. 2. The feeding point A essentially corresponds to the cross-sectional area of the chute exit 4.2, so that the feeding point A in this case extends over a large area of the spreading devices 3.1, 3.2. In particular, the feeding point A extends over a large angular range along the respective direction of rotation o of the spreading devices 3.1, 3.2.

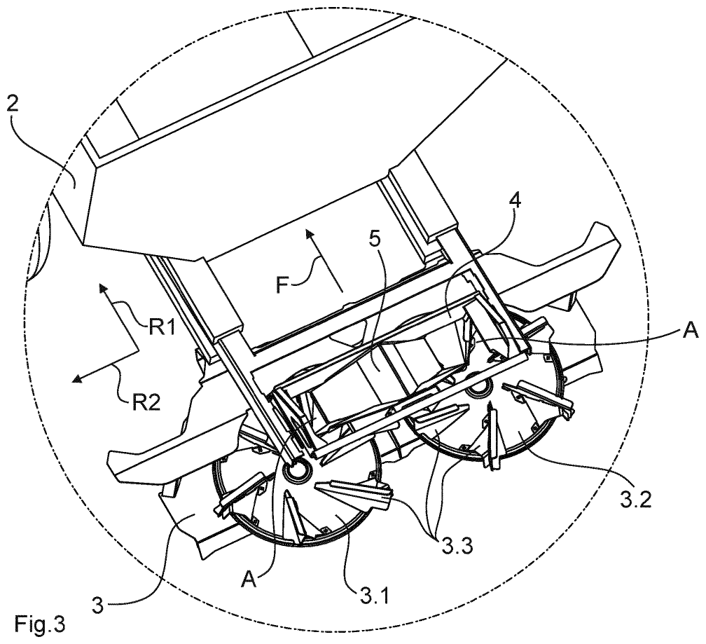

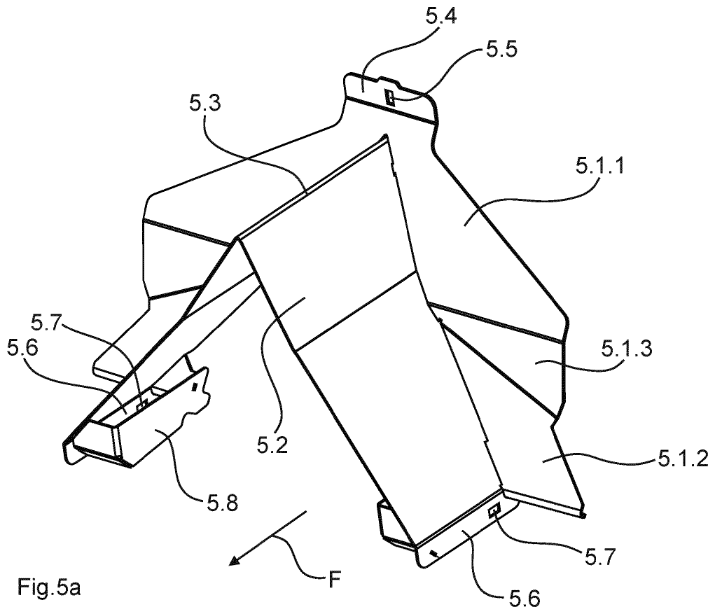

In order to adjust the feeding point A, the spreading device 1 according to the disclosure is provided with an additional chute 5 that can be inserted into the feed chute 4, the function and structure of which is explained below on the basis of the illustrations in FIGS. 3 and 5a and b.

As shown in FIG. 3, an additional chute 5 is inserted into the feed chute 4 to adjust the chute exit 4.2. As a result, the feeding point A is adjusted both in the direction of R₁, which extends in the direction of travel F, and in the direction of R₂, which extends transversely to the direction of travel F, compared to the situation without the additional chute 5 (see FIG. 2). The feeding point A adjusted by the feed chute 5 comprises a smaller cross-sectional area. Furthermore, the smaller feeding point A is now located in the directions of rotation φ₁, φ₂ of the spreading devices 3.1, 3.2 in front of the feeding point A as it is formed by the feed chute 4 alone. This can be seen, for example, by comparing the illustrations in FIGS. 2 and 3. The displacement of feeding point A results from the smaller cross-sectional area of the chute exit 4.2 of the feed chute 4, which results when the additional chute 5 is inserted.

With the additional chute 5 inserted into the feed chute 4 as shown in FIGS. 3, 8 and 9, the feeding point A is adjusted in such a way that the spreading material S hits the spreading devices 3.1, 3.2 earlier in relation to the directions of rotation (φ₁, φ₂. Such an “early” feeding point A has proven to be advantageous for a uniform spreading pattern when the spreading material S, in particular lime, comprises an increased degree of moisture. Alternatively, it is also conceivable to adjust the feeding point A in the opposite direction by means of an additional chute 5 inserted into the feed chute 4, so that the spreading material S strikes the spreading devices 3.1, 3.2 later in relation to the directions of rotation φ₁, φ₂. The additional chute 5 thus provides a simple and user-friendly way of adjusting the feeding point A to the properties of the spreading material S.

The structural design of the additional chute 5 is explained below with the help of the illustrations in FIG. 5a and b. The additional chute 5 is configured for insertion into the feed chute 4, which is configured as a double chute, in the manner of a double ramp with an angular cross-section, see FIG. 5a. The additional chute 5 is also configured to be mirror-symmetrical to a separating point 5.3, which extends linearly in the direction of travel F. Two lateral adjustment ramps 5.2, which are inclined transversely to the direction of travel F, extend away from the separating point 5.3 to adjust the chute exit 4.2 in the direction R₂. At its rear side, the additional chute 5 comprises two longitudinal adjustment ramps 5.1, which are inclined in the direction of travel F, for adjusting the chute exit 4.2 in the other direction R₁. The cross-sectional area of the chute exit 4.2 can be adjusted by means of the inclination of the longitudinal adjustment ramps 5.1 and the lateral adjustment ramps 5.2, resulting in an adjusted feeding point A.

The longitudinal adjustment ramps 5.1 and the lateral adjustment ramps 5.2 each comprise areas with different gradients for improved guidance of the spreading material S, as shown in FIG. 5a. As a result, the longitudinal adjustment ramps 5.1 and the lateral adjustment ramps 5.2 run at an angle between the chute inlet 4.1 and the chute exit 4.2. In particular, the additional chute 5 is configured such that its lateral adjustment ramps 5.2 are configured to be steeper in the area of the chute inlet 4.1, i.e., they comprise a greater slope there than in the area of the chute outlet 4.2. By contrast, the longitudinal adjustment ramps 5. 1, on the other hand, comprise an inclined inlet area 5.1.1 in the vertical direction near the chute inlet 4.1 for guiding the spreading material S and also an inclined outlet area 5.1.2 for guiding the spreading material S in the area of the chute exit 4.2. A transition area 5.1.3 is arranged between the respective inlet area 5.1.1 and the outlet area 5.1.2, which runs at an angle to the inlet area 5.1.1 and the outlet area 5.1.2 and, in particular, extends vertically, see FIGS. 5a and 5b.

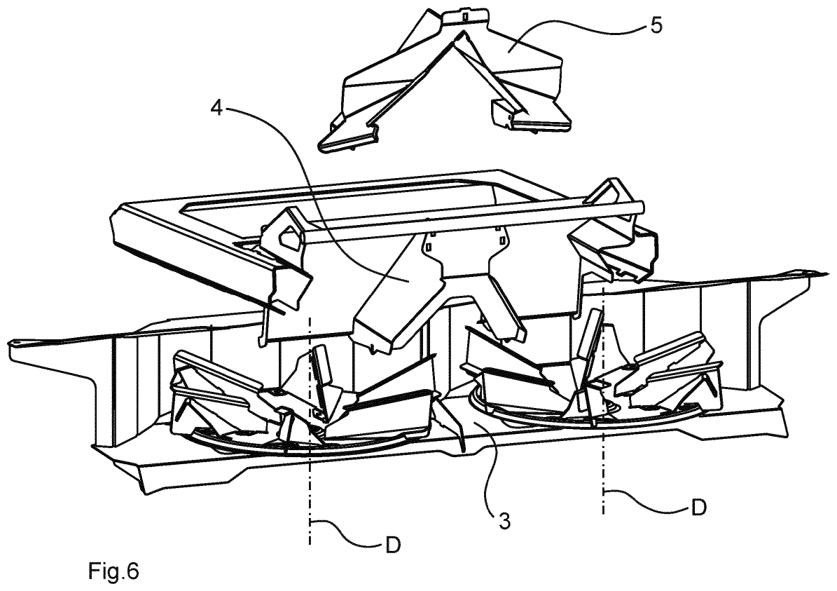

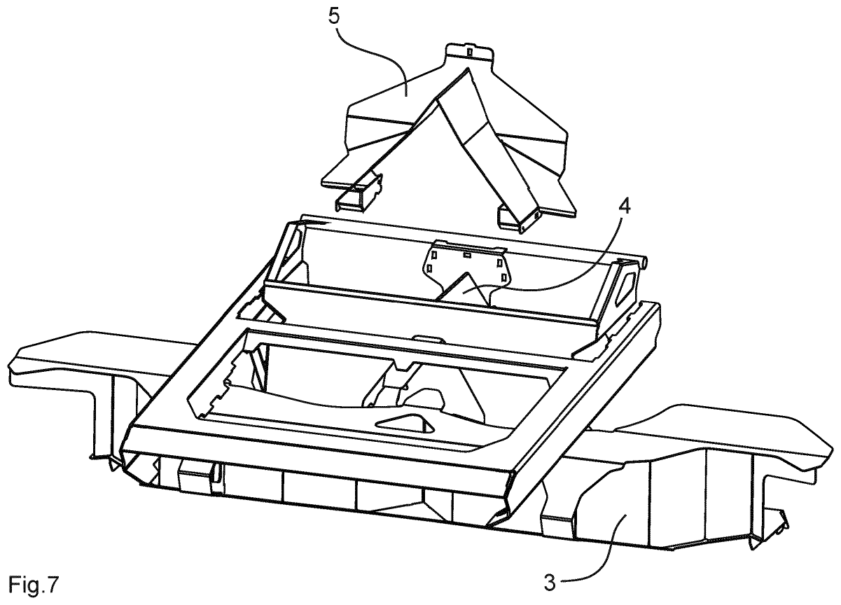

As can be seen from the above description and also from the illustrations in FIGS. 6 and 7, the additional chute 5 configured as a double additional chute for insertion into the feed chute 4 comprises a saddle-like, approximately roof-like insertion shape. The additional chute 5 can be mounted in particular with a lower side of the separating point 5.3 on an upper side of the separating point 4.6 of the feed chute 4 configured as a double chute. This user- and assembly-friendly mounting of the additional chute 5 on the feed chute 4 ensures secure storage of the additional chute 5 during distribution of the spreading material S. Furthermore, the complementary shapes of the feed chute 4 and the additional chute 5 allow the additional chute 5 to be easily self-positioned by its own weight and the pressure applied by the incoming spreading material S. In addition, this reliably prevents incorrect installation of the additional chute 5 in the feed chute 4. In the inserted position, the lateral adjustment ramps 5.2 of the additional chute 5 cover the chute segments 4.4 of the feed chute 4, see, for example, FIG. 8. This further supports the secure mounting of the additional chute 5 on the feed chute 4. Furthermore, the function of separating the spreading material S into two subsets T₁, T₂ can be easily maintained.

The additional chute 5 can be releasably attached to the feed chute 4 in the inserted position. For this purpose, the additional chute 5 comprises a tab-like fastening area 5.4 that extends essentially vertically from the upper side of the longitudinal adjustment ramp 5.1 and transversely to the separating point 5.3. A fastening hole 5.5 is arranged in the center of the fastening area 5.4, by means of which the additional chute 5 can be fastened to a corresponding fastening area of the feed chute 4 by means of bolts or screws, see FIG. 7. In addition to a screw connection, the additional chute 4 can also be configured so that it can be attached to the feed chute 4 without tools, in particular by means of quick-release clamping devices.

In addition to the fastening area 5.4, the additional chute 5 comprises two further tab-like fastening areas 5.6 that extend downwards from the transverse adjustment ramps 5.2. These fastening areas 5.6 extend essentially parallel to the separating point 5.3 and each comprise a fastening hole 5.7 arranged in the area of the rear side of the additional chute 5. The additional chute 5 can also be fastened by means of bolts or screws to a corresponding fastening area of the feed chute 4 via these fastening areas 5.6, see FIG. 7. In addition, the additional chute 5 has two box-like mounting elements 5.8, which are arranged on the underside of the transverse adjustment ramps 5.2 and extend parallel to the fastening areas 5.6. These mounting elements 5.8 serve as spacers for user-friendly fastening of the additional chute 5 to the feed chute.

On the basis of the above explanations and also the illustrations in FIG. 5a and b, it becomes clear that the additional chute 5 is configured such that, on its rear side, it is at least partially closed due to the longitudinal adjustment ramps 5.1 and, on its front side, it is open. When the additional chute 5 is inserted into the feed chute 4, their interaction results in a funnel that is closed around its circumference, at least in large parts, see FIG. 9. This ensures that the spreading material S is reliably guided from the chute inlet 4.1 to the chute exit 4.2.

The additional chute 5 according to the disclosure, which can be made, for example, of sheet metal moldings or bent sheet metal parts, can be inserted into the feed chute 4 in a simple and time-saving manner. Therefore, in order to enable a uniform spreading pattern for spreading materials S that differ greatly, in particular for spreading materials S with significantly different degrees of moisture or flow properties, it may be useful to provide several additional chutes 5 for a spreading device 1, which can be exchanged as required. These additional chutes 5 can be equipped with different configured longitudinal adjustment ramps 5.1 and/or lateral adjustment ramps 5.2 to adjust the chute exit 4.2. For example, it is conceivable to provide an additional chute 5 for particularly moist spreading material S, which adjusts the chute exit 4.2 in such a way that a particularly early feeding point A is obtained relative to the directions of rotation φ of the spreading devices 3.1, 3.2 of the spreading unit 3. In the case of particularly dry or particularly free-flowing spreading material S, for example, it may also be advantageous to use an additional chute 5, via which a particularly late feeding point A can be set. The setting of an early or late feeding point A in relation to the directions of rotation φ can be achieved by a corresponding design of the longitudinal adjustment ramps 5.1 and lateral adjustment ramps 5.2.

The spreading device 1 described above is characterized by the fact that the feeding point A of the spreading material S onto the spreading devices 3.1, 3.2 can be adjusted in a structurally simple and user-friendly manner.

### REFERENCE SIGNS

1 spreading device
2 storage container
3 spreading unit
3.1 spreading device
3.2 spreading device
3.3 spreading vane
4 feed chute
4.1 chute inlet
4.2 chute outlet
4.3 front wall
4.4 chute segment
4.5 chute segment
4.6 separating point
5 additional chute
5.1 longitudinal adjustment ramp
5.1.1 inlet area
5.1.2 outlet area
5.1.3 transition area
5.2 lateral adjustment ramp
5.3 separating point
5.4 fastening area
5.5 fastening hole
5.6 fastening area
5.7 fastening hole
5.8 mounting element
7 chassis
7.1 impeller
7.2 coupling device
8 tractor
A feeding point
D rotation axis
F direction of travel
N utilizable area
R direction
S spreading material
T₁ subset
T₂ subset
Q₁ direction of rotation
Q₂ direction of rotation

1. An agricultural spreading device, comprising:
a storage container for receiving a spreading material, a spreading unit for distributing the spreading material on an utilizable area, a feed chute with a chute inlet for introducing the spreading material to be fed from the storage container and a chute outlet for delivering the spreading material to the spreading unit, and an additional chute that is insertable into the feed chute for adjusting the chute outlet.

2. The spreading device according to claim 1, further comprising an additional chute configured in such a way that the chute outlet is adjusted in two directions by inserting the additional chute.

3. The spreading device according to claim 2, wherein one of the directions extends longitudinally and another of the directions extends transversely with respect to direction of travel of the spreading device.

4. The spreading device according to claim 2, wherein the additional chute is configured in the manner of a ramp with an angular cross section.

5. The spreading device according to claim 4, wherein the additional chute comprises a longitudinal adjustment ramp, inclined longitudinally to the direction of travel, for adjusting the chute outlet in the one direction and a lateral adjustment ramp inclined transversely to the direction of travel for adjusting the chute outlet in the other direction.

6. The spreading device according to claim 5, wherein the lateral adjustment ramp of the additional chute at least partially covers one of chute segments of the feed chute in an inserted position.

7. The spreading device according to claim 2, wherein the additional chute is configured as a double additional chute with two longitudinal adjustment ramps, two lateral adjustment ramps and a separating point arranged between the lateral adjustment ramps.

8. The spreading device according to claim 7, wherein the additional chute comprises a saddle-like insertion shape for insertion into the feed chute.

9. The spreading device according to claim 7, wherein the additional chute is configured such that the additional chute is mountable with a lower side of the separating point on an upper side of a separating point of the feed chute configured as the double additional chute.

10. The spreading device according to claim 1, wherein the additional chute is releasably attachable to the feed chute in the inserted position.

11. The spreading device according to claim 5, further including a plurality of interchangeable additional chutes for a stepwise adjustment of the chute outlet.

12. The spreading device according to claim 11, characterized in that the longitudinal and/or lateral adjustment ramps of the additional chutes differ from one another.

13. The spreading device according to claim 1, wherein a feeding point is adjusted in such a way that the feeding point in a direction of rotation of the spreading devices is arranged before the feeding point without the additional chute inserted.

14. The spreading device according to claim 10, wherein the additional chute is releasably attachable to the feed chute in the inserted position by screwing, tool-free or using a quick-release clamping devices.
